(19) United States
(12) Patent Application Publication
(10) Pub. No.: US 2004/0037501 A1
(43) Pub. Date: Feb. 26, 2004

(54) Operational tuning of optical structures

(76) Inventors: Dimitrii Yu Stepanov, New South Wales (AU); Fred Crous, New South Wales (AU)

Correspondence Address: BANNER & WITCOFF, 1001 G STREET N W, SUITE 1100, WASHINGTON, DC, 20001, US

(21) Appl. No.: 10/416,212

(22) PCT Filed: Nov. 16, 2001
(86) PCT No.: PCT/AU01/01493

(30) Foreign Application Priority Data
Nov. 16, 2000 (AU) PR 1512
May 4, 2001 (AU) PR 4777

(51) Int. Cl. G02B 6/34

(52) U.S. Cl. 385/37

(57) ABSTRACT

A method of operational tuning of an optical structure, such as a Bragg grating, incorporated in an optical waveguide (24) mounted in a packaging device (10) is disclosed. The method comprises the steps of applying a transverse compressive load (33) to a first longitudinal member (12) of the packaging device (10), the load (33) being above a non-elastic deformation threshold of the first material member (12), to achieve a longitudinal expansion (37) of the first material member (12). The longitudinal expansion (37) results in the tuning being affected through a lever mechanism operating under relative movement of the first material member (12) and a second material member (14) of the packaging device (10).

### FIELD OF THE INVENTION

The present invention relates broadly to a method of operational tuning of optical structures incorporated in an optical waveguide and to an apparatus for implementing the method.

The present invention will be described herein with reference to an optical fibre, and particularly with reference to a grating structure incorporated within the optical fibre. However, it will be appreciated that the present invention does have broad applications, including e.g. to planar waveguides and to other optical structures including e.g. tapered waveguide structures or modulator structures.

### BACKGROUND OF THE INVENTION

As a result of the increasing utilisation of optical components in e.g. communications networks, the design of suitable packaging devices for optical components, e.g. packaging devices for optical fibre devices, has become an important aspect of the photonics technology field.

Also, there is a need for facilitating tuning of optical devices contained in a waveguide package to meet required specifications. Initially, operational tuning is used to set an operational point of the device. Furthermore, functional tuning of the device around its operational point may be desired.

Preferred embodiments of the present invention seek to provide a novel method of operational tuning.

### SUMMARY OF THE INVENTION

In accordance with a first aspect of the present invention there is provided a method of operational tuning of an optical structure incorporated in an optical waveguide mounted in a packaging device, the method comprising the step of applying a transverse compressive load to a first longitudinal material member of the packaging device and above a non-elastic deformation threshold of the first material member, to achieve a longitudinal expansion of the first material member.

The transverse compressive load induces a strain at right angles to the applied load according to Poisson's ratio of the material, resulting in a longitudinal strain in the member and, if the compressive load is above a certain value, in permanent longitudinal deformation. The permanent deformation can provide a very precise and accurate means to achieve a permanently tuned device.

In one embodiment, the step of applying the transverse compressive load comprises applying forces to load regions on opposite sides of the first material member. Advantageously, the load regions are positioned directly opposite to each other.

In a preferred embodiment, the transverse compressive load is applied in a manner such that the areas of the load regions to which the forces are applied are chosen such that elastic deformations caused by the application of the compressive load are reduced. Advantageously, the areas of the load regions are reduced.

In one embodiment, the transverse compressive load is applied utilising intermediate members arranged to have the forces applied to them and transfer the same to the load regions of the first material members. The shape of a contact portion of each intermediate member is preferably chosen such that, in use, the areas of the load regions are reduced. Preferably, the shape of each contact portion is chosen in a manner such that the likelihood of creating a crack in the first material member is reduced.

In a preferred embodiment, the shape of each contact portion is chosen to be of a substantially triangular shape with an obtuse angle.

In one embodiment, the longitudinal expansion of the first material member results in the tuning being effected through a lever mechanism operating under relative movement of the first material member and a second material member of the packaging device.

In accordance with a second aspect of the present invention there is provided an apparatus for operational tuning of an optical structure incorporated in an optical waveguide mounted in a packaging device, the apparatus comprising a load application unit arranged, in use, to apply a transverse compressive load to a first longitudinal material member of the packaging device and above a non-elastic deformation threshold of the first material member, to achieve a longitudinal expansion of the first material member.

In one embodiment, the load application unit comprises two force application members arranged, in use, to apply forces to load regions on opposite sides of the first material member. Advantageously, the load application members are arranged in a manner such that, in use, the load regions are directly opposite each other.

The apparatus may further comprise intermediate members arranged to have the forces applied to them and transfer the same to the load regions of the first material member. The shape of a contact portion of each intermediate member is preferably chosen such that, in use, the areas of the load regions are minimised. Preferably, the shape of each contact portion is chosen in a manner such that, in use, the likelihood of creating a crack in the first material member is reduced. In one embodiment, the shape of each contact portion is chosen to be of a substantially triangular shape with an obtuse angle.

In one embodiment, the apparatus is further arranged in a manner such that, in use, the longitudinal expansion of the first material member results in the tuning being effected through a lever mechanism operating under relative movement of the first material member and a second material member of the packaging device.

Preferred forms of the present invention will now be described, by way of example only, with reference to the accompanying drawings.

### BRIEF DESCRIPTION OF THE DRAWINGS

FIG. 1 shows a schematic diagram illustrating a fibre packaging device for use in an operational tuning method embodying the present invention.

FIGS. 2A and 2B are a schematic diagrams showing bottom views of the fibre packaging device of FIG. 1 and illustrating a method of operational tuning embodying the present invention.

FIG. 3 is a schematic diagram illustrating an exploded view of another fibre packaging device for use in an operational tuning method embodying the present invention.

FIG. 4 is a schematic diagram illustrating an exploded view of another fibre packaging device for use in an operational tuning method embodying the present invention.

FIG. 5 is a schematic diagram illustrating another fibre packaging device for use in an operational tuning method embodying the present invention.

FIG. 6 is a schematic diagram illustrating another fibre packaging device for use in an operational tuning method embodying the present invention.

FIG. 7A is a schematic front view of an apparatus for implementing an operational tuning method embodying the present invention.

FIG. 7B is a schematic side view of the apparatus for implementing an operational tuning method embodying the present invention of FIG. 7A.

### DETAILED DESCRIPTION OF THE EMBODIMENTS

The preferred embodiments described provide a method of operational tuning and an apparatus for operational tuning, which provide a very precise and accurate means to achieve a permanently tuned device.

The packaging device 10 comprises a first beam 12 formed from a high thermal expansion coefficient (TEC) material, and a second beam 14 formed from a lower TEC material. The first and second beams, 12, 14, substantially coextend one above the other.

The packaging device 10 further comprises a pair of lever arms 16. Each lever arm 16 is pivotally connected to the lower beam 12 (high TEC) at opposing ends thereof. The pivotal connection is effected through axis members 18.

Furthermore, each lever arm 16 is rotatably connected to the upper beam 14, (lower TEC) again at opposing ends thereof. The rotatable connection to the upper beam 14 is effected utilising axis members 20.

The free ends 22 of the lever arms 16 are connected to an optical fibre 24 utilising a suitable adhesive material 26. An initial tension is applied to the optical fibre 24 either prior to curing the adhesive material 26, during curing, or afterwards.

In the packaging device 10, temperature induced refractive index changes in the optical fibre 24 can be compensated for by utilising a lever mechanism operating under temperature induced relative movement between the high TEC material beam 12 and the lower TEC material beam 14.

More particularly, if a temperature increase is experienced in the ambient around the packaging device 10, a reduction in tension (indicated by arrows 28) is induced in the optical fibre 24, caused by a greater expansion of the high TEC material beam 12 (as indicated by arrows 30) compared with the lower TEC bar 14. As will be readily appreciated by a person skilled in the art, the greater expansion of beam 12 effects movement of the respective ends 22 of the arms 16 towards each other, thereby inducing the negative strain 28 in the optical fibre 24. Through the elasto-optic effect, the negative strain 28 is used to compensate for the temperature induced refractive index change in the optical fibre 24.

It will also be appreciated by the person skilled in the art, that in the packaging device 10 through suitable selection of the relevant dimensions 32, 34 in the lever mechanism, the compensating negative strain caused by the thermally induced relative movement between beams 12 and 14 can be chosen to suit various compensating requirements.

It is noted that as a result of the initial tensioning of the optical fibre 24 (see above), it can be ensured that during operation of the waveguide packaging device to compensate for temperature induced changes, the compressive stress exerted onto the optical fibre 24 by the lever mechanism in case of a temperature increase will not result in any bending of the optical fibre, which would be detrimental to the device. Thus, the initial tensioning parameters are preferably appropriately chosen to accommodation temperature compensation over a given temperature range.

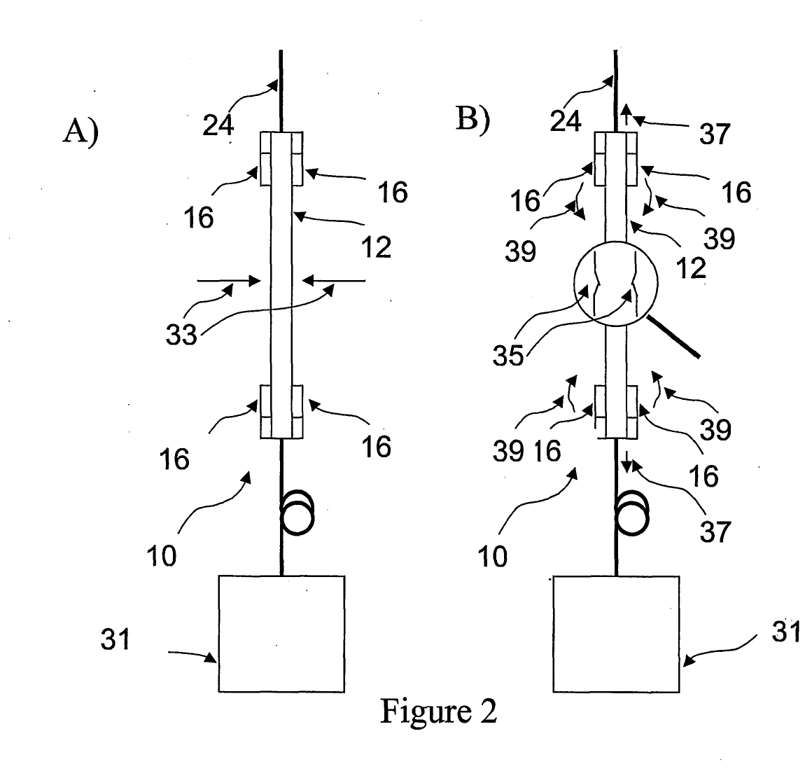

Turning now to FIGS. 2A and B, there is illustrated a method of operational tuning embodying the present invention when applied to an optical device incorporated in the optical fibre 24 mounted in the waveguide packaging device 10. FIGS. 2A and B show schematic bottom views of the waveguide packaging device 10. As illustrated in FIG. 2A, an optical testing apparatus 31 is connected to the optical fibre 24, to measure properties of an optical device incorporated in the optical fibre 24 mounted in the waveguide packaging device 10. For example, the optical test apparatus 31 could be arranged to measure the reflectivity of a Bragg grating to determine the centre wavelengths of the Bragg grating. For operational tuning of the centre wavelength of the Bragg grating, a transverse load is applied, in the example embodiment to the high TEC material beam 12 of the waveguide packaging device 10. The application of the transverse load is indicated in FIG. 2A by arrows 33.

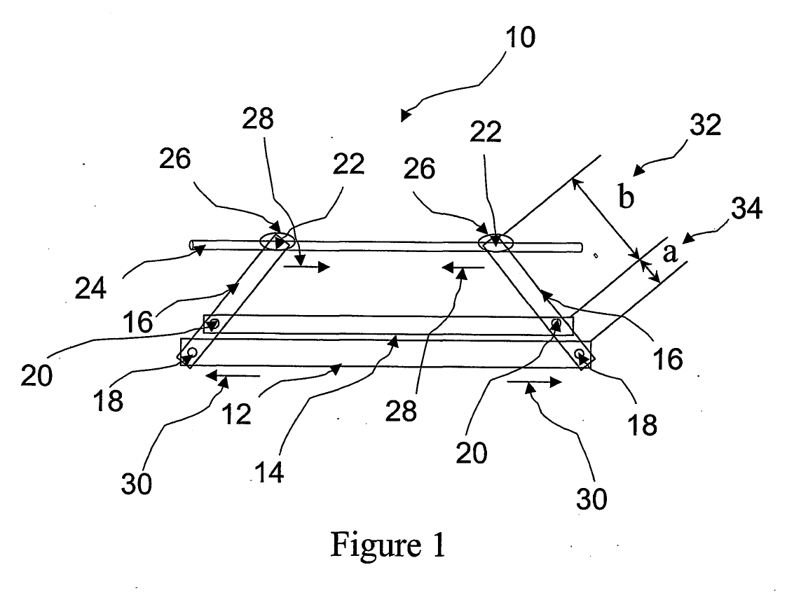

If the transverse load is appropriately chosen, non-elastic deformations of the high TEC material beam 12 occur in the regions to which the load is applied, leading to the formation of indentations 35 on opposite sides of the high TEC material beam 12, as shown in FIG. 2B. It will be appreciated by a person skilled in the art that the formation of the indentations 34, which in the example embodiment extend along the entire transverse width of the high TEC material beam 12, result in a small elongation of the high TEC material member 12, as indicated by arrows 37 at opposite ends of the high TEC material beam 12 in FIG. 2B. This elongation in turn results in a movement of the lever arms 16 towards each other, as indicated by arrows 39, similar to movement of the lever arm 16 to effect temperature compensation as a result of a larger temperature induced expansion of the high TEC material beam 12 described above with reference to FIG. 1.

Accordingly, as a result of the elasto-optic effect, the compressive strain induced in the optical fibre 24 between the lever arms 16 is used to tune the centre wavelength of the Bragg grating incorporated in the optical fibre 24. The tuning can be monitored through continued testing in the optical testing apparatus 31, until the desired centre wavelength has been set. It will be appreciated by a person skilled in the art that the operational tuning method of the preferred embodiment is not limited to tuning by inducing negative strain in the optical fibre 24, but can also be used to induce positive strain for tuning purposes when the transverse load is applied to the low TEC material member 20, an elongation of which will result in the lever arms 16 moving away from each other.

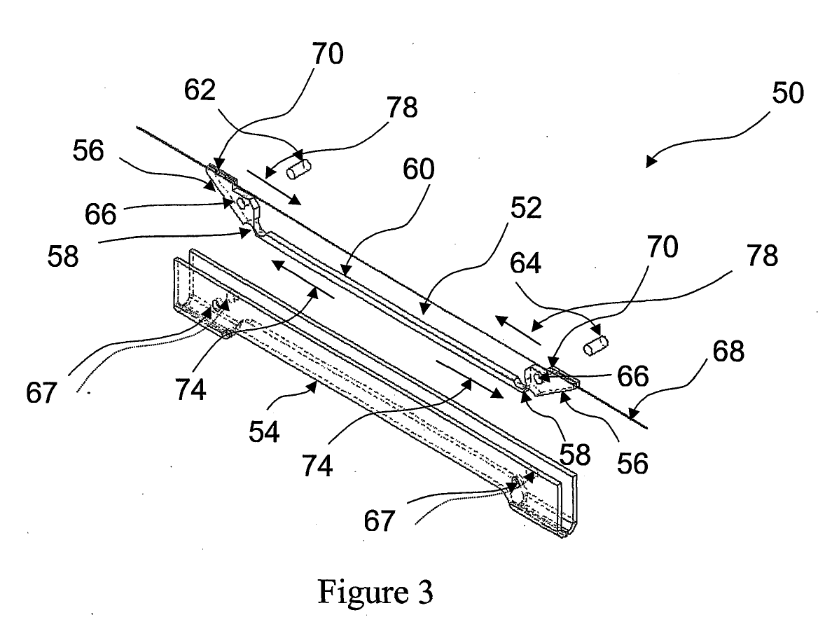

In the following, a variety of other waveguide packaging devices will be described with reference to FIGS. 3 to 6, to which the present invention can be readily applied. However, it will be appreciated by the person skilled in the art that the present invention is not limited to the described example waveguide packaging devices.

Turning to FIG. 3, in another packaging design 50, a high TEC material member 52 is disposed within a U-shaped lower TEC material member 54. The high TEC material member 52 comprises two lever arm end portions 56. Flexures 58 are formed between the respective end portions 56 and a main body 60 of the high TEC material member 52. The flexing connecting portions 58 effect a pivotal connection between the lever arm end portions 56 and the main body 60 of the high TEC material member 52.

The lever arm end portions 56 are rotatably mounted within the U-shaped lower TEC material member 54 by way of axis members in the form of cylinders 62, 64, which are received in openings 66, 67 formed in the lever arm end portions 56 and the U-shaped lower TEC material member 54 respectively.

An optical fibre 68 is mounted within grooves 70 formed in the lever arm end portions 56 by way of a suitable adhesive material 72.

It will be appreciated by the person skilled in the art that the operation of the packaging device 50 to compensate for temperature induced refractive index changes in the optical fibre 68 is functionally identical to the operation of the packaging device 10 described above with reference to FIG. 1. Greater expansion of the main body 60 of the high TEC material member 52 (indicated by arrows 74) relative to the lower TEC material member 54 effects movement of the top portions 76 of the lever arm end portions 56 towards each other, which in turn induces negative strain in the optical fibre 68, as indicated by arrows 78.

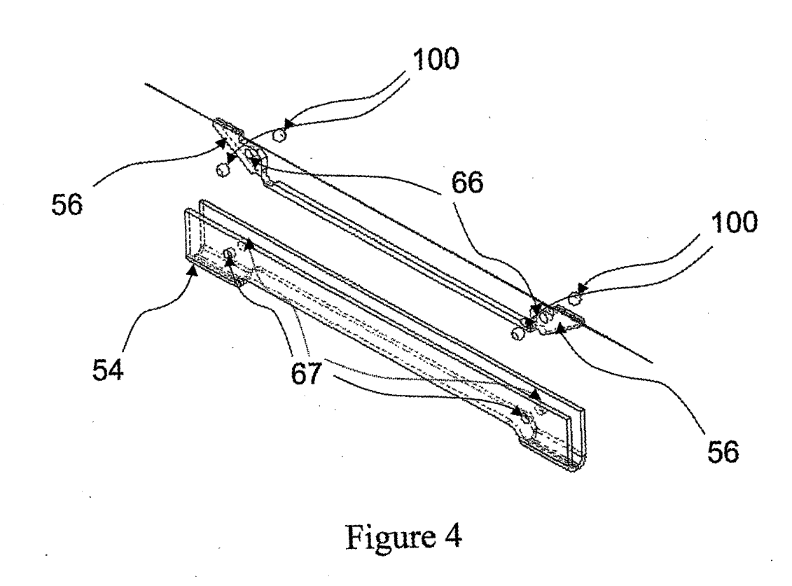

In another package design shown in FIG. 4, axis members are provided in the form of bearing balls 100. Each bearing ball 100 is received between one of the openings 67 formed in the U-shaped lower TEC material member 54 and one of the openings 66 formed in the lever arm end portions 56.

In yet another embodiment, the lever arm end portions 56 can be rotatably mounted within the U-shaped lower TEC material member 54 by way of protrusions formed on internal walls thereof, which are received in corresponding openings formed in the lever arm end portions 56.

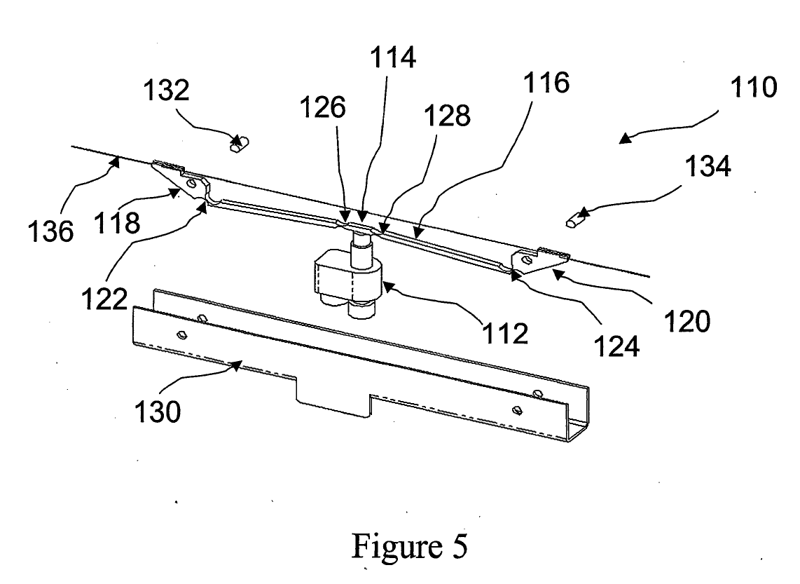

In another package design shown in FIG. 5, a packaging device 110 further comprises a functional tuning means in the form of pico-motor 112 connected to a centre portion 114 of a first material member 116. The first material member 116 comprises two arm portions 118, 120 pivotally connected to the main portion of the first material member 116 by way of flexures 122, 124 respectively. Two further flexures 126, 128 are formed on either side of the centre portion 114 of the first material member 116.

The respective arms 118, 120 are rotatably mounted within a U-shaped second material member 130 by way of axis members in the form of cylinders 132, 134.

An optical fibre 136 is mounted within grooves located at end portions of the respective arms 118, 120 by way of a suitable epoxy.

It will be appreciated by a person skilled in the art that through adjustment of the pico-motor 112, upward and downward movement of the centre portion 114 of the first material member 116 will induce strain in the optical fibre 136 by way of the arm portions 118 and 120 for functional tuning.

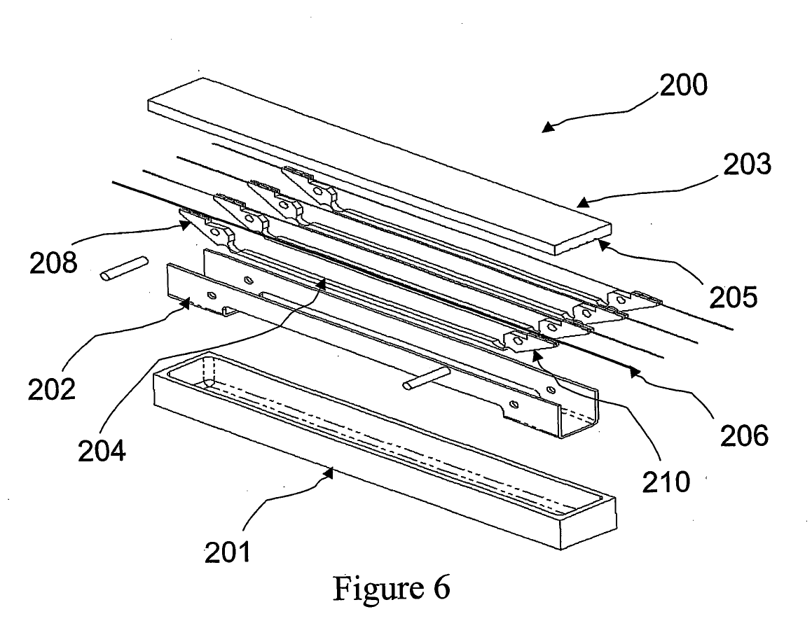

Turning now to FIG. 6, in another waveguide packaging device 200 comprises a widened U-shaped second material member 202, with a plurality of first material members, e.g. 204, mounted therein.

A plurality of optical fibres e.g. 206, are mounted between respective arm portions, e.g. 208, 210 of the first material members, e.g. 204. It will be appreciated by a person skilled in the art that each individual first material member e.g. 204 operates in conjunction with the U-shaped second material member 202 as described above with reference to FIGS. 3, 4 or 5, to provide temperature compensated packaging of the individual optical fibres e.g. 206. The packaging device 200 further comprises a dedicated secondary package structure in the form of a box 201 and corresponding lid 203. Grooves e.g. 205 are provided on the inner surface of the lid, for feed-through of the optical fibres e.g. 206. Appropriate support/feedthrough structures for the optical fibres extending from the box 201 may be provided.

Furthermore, it will be appreciated by the person skilled in the art that through variation of the configuration of the respective arm portions e.g. 208, 210, different compensation characteristics can be realised for the individual optical fibres.

In another embodiment, one or more of the second material members 204 can be provided with tuning means to facilitate operational or functional tuning (compare FIG. 5 for single-fibre tunable embodiment).

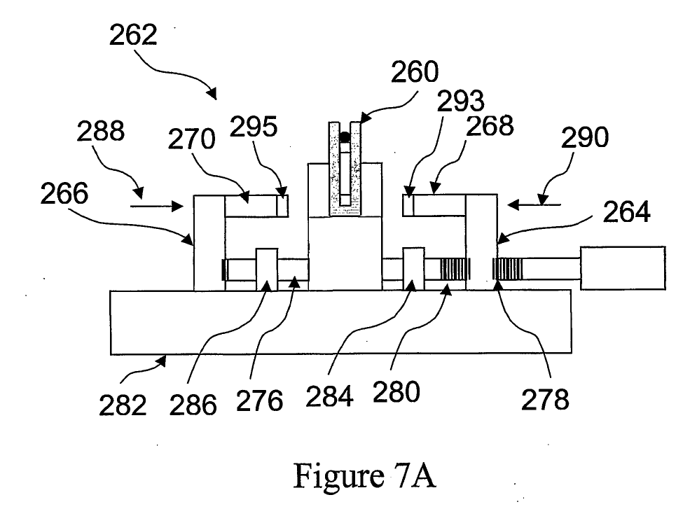

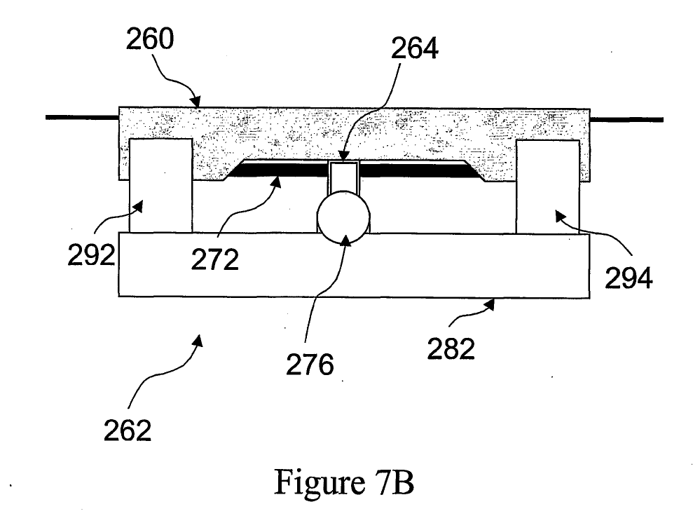

Turning now to FIGS. 7A (front view) and 7B (side view), there is illustrated a device for implementing a method of operational tuning embodying the present invention. A waveguide package 260 of the type of waveguide package 50 described above with reference to FIG. 3 is mounted within an operational tuning device 262 by way of support posts 292, 294. The operational tuning device 262 incorporates two arms 264, 266 on which are mounted load application blocks 268, 270 respectively.

The waveguide package 260 is positioned in a manner such that the load application blocks 268, 270 will make contact with the higher TEC material member 272 of the waveguide package 260 at opposing sides thereof.

The arms 264, 266 are configured on a movement mechanism comprising a rotatable rod 276 rotatably connected at one end to one of the arms 266 of the operational tuning device 262.

The other arm 264 comprises a threaded hole 278 which is positioned on a corresponding threaded portion 280 of the rotatable rod 276.

The operational tuning device 262 further comprises a base plate 282 onto which the rotatable rod 276 is rotatably mounted by way of latches 284, 286.

It will be appreciated by a person skilled in the art that the load application blocks 268, 270 can thus be forced against the higher TEC member 272 from opposing sides thereof as indicated by arrows 288, 290, to apply a predetermined load for operational tuning.

In the exemplary embodiment shown in FIGS. 7A and 7B, the contact portions 293, 295 of the load application blocks 268, 270 respectively are of a substantially triangular shape with an obtuse angle, thereby reducing the area in which the load is applied to the higher TEC material member 272. Such a design can facilitate that non-elastic deformation occurs at a predetermined load in the reduced area (as compared with a design in which the area is larger).

As a further advantage, applying the load to a smaller area reduces adverse effects that can be caused by variations of the elastic properties of the higher TEC material member 272, which may lead to non-uniform deformation of the higher TEC material member 272. This could e.g. result in bending of the higher TEC material member 272, which may adversely affect the utility of the waveguide package 260 after the operational tuning.

Furthermore, reducing the area also reduces elastic deformation caused by the application of the compressive load.

In the preferred embodiment, the obtuse angle chosen for the triangular contact portions 293, 295 can at the same time reduce the likelihood of formation of a crack in the higher TEC material member 272 as compared to e.g. a triangular shape with an acute angle.

It will be appreciated by the person skilled in the art that numerous variations and/or modifications may be made to the present invention as shown in these specific embodiments without departing from the spirit or scope of the invention as broadly described. The present embodiments are, therefore, to be considered in all respects to be illustrative and not restrictive.

For example, whilst the above description in relation to FIG. 7A and 7B specifies a number of specific details in relation to a preferred embodiment, it will be appreciated by the person skilled in the art that numerous other devices or mechanisms for implementing the method embodying the present invention can be utilised and do fall within the scope of the present invention.

Further, it will be appreciated by the person skilled in the art that the present invention is not limited to use on waveguide packaging devices described in this specification for illustrative purposes. Rather, the present invention extends to any other waveguide packaging design suitable for effecting tuning through the application of a transverse compressive load to a longitudinal material member of that packaging device and above a non-elastic deformation threshold to achieve a longitudinal expansion of the first material member for effecting tuning. Other waveguide packaging designs to which the present invention extends do include, but are not limited to, bi-metallic waveguide packaging designs, and waveguide packaging designs in which relative movement between different TEC material members is utilised directly for temperature compensation, i.e. not through a lever mechanism. Importantly, the present invention is also not limited to use with temperature compensated packages but can be applied to non-temperature compensated packaging designs.

In the claims that follow and in the summary of the invention, except where the context requires otherwise due to express language or necessary implication, the word “comprising” is used in the sense of “including”, i.e. the features specified may be associated with further features in various embodiments of the invention.

1. A method of operational tuning of an optical structure incorporated in an optical waveguide mounted in a packaging device, the method comprising the step of:
applying a transverse compressive load to a first longitudinal material member of the packaging device and above a non-elastic deformation threshold of the first material member, to achieve a longitudinal expansion of the first material member.

2. A method as claimed in claim 1, wherein the step of applying the transverse compressive load comprises applying forces to load regions on opposite sides of the first material members.

3. A method as claimed in claim 2, wherein the load regions are positioned directly opposite to each other.

4. A method as claimed in any one of the preceding claims, wherein the transverse compressive load is applied in a manner such that the areas of the load regions to which the forces are applied are chosen such that elastic deformations caused by the application of the compressive load are reduced.

5. A method as claimed in claim 4, wherein the areas of the load regions are reduced.

6. A method as claimed in any one of the preceding claims, wherein the transverse compressive load is applied utilising intermediate members arranged to have the forces applied to them and transfer the same to the load regions of the first material member.

7. A method as claimed in claim 6, wherein the shape of a contact portion of each intermediate member is preferably chosen such that, the areas of the load regions are reduced.

8. A method as claimed in claims 6 or 7, wherein the shape of the or a contact portion of each of the intermediate members is chosen in a manner such that the likelihood of creating a crack in the first material member is reduced.

9. A method as claimed in any one of claims 6 to 8, wherein the shape of the or a contact portion of each intermediate member is chosen to be of a substantially triangular shape with an obtuse angle.

10. A method as claimed in any one of the preceding claims, wherein the longitudinal expansion of the first material member results in the tuning being effected through a lever mechanism operating under relative movement of the first material member and a second material member of the packaging device.

11. An apparatus for operational tuning of an optical structure incorporated in an optical waveguide mounted in a packaging device, the apparatus comprising:
a load application unit arranged, in use, to apply a transverse compressive load to a first longitudinal material member of the packaging device and above a non-elastic deformation threshold of the first material member, to achieve a longitudinal expansion of the first material member.

12. An apparatus as claimed in claim 11, wherein the load application unit comprises two force application members arranged, in use, to apply forces to load regions on opposite sides of the first material member.

13. An apparatus as claimed in claim 12, wherein the load application members are arranged in a manner such that, in use, the load regions are directly opposite each other.

14. An apparatus as claimed in claims 12 or 13, wherein the apparatus further comprises intermediate members arranged to have the forces applied to them and transfer the same to the load regions of the first material member.

15. An apparatus as claimed in claim 14, wherein the shape of a contact portion of each intermediate member is chosen such that, in use, the areas of the load regions are minimised.

16. An apparatus as claimed in claims 14 or 15, wherein the shape of the or a contact portion of each intermediate member is chosen in a manner such that, in use, the likelihood of creating a track in the first material member is reduced.

17. An apparatus as claimed in any one of claims 14 to 16, wherein the shape of the or a contact portion of each intermediate member is chosen to be of a substantially triangular shape with an obtuse angle.

18. An apparatus as claimed in any one of claims 11 to 17, wherein the apparatus is further arranged in a manner such that, in use, the longitudinal expansion of the first material member results in the tuning being effected through a lever mechanism operating under relative movement of the first material member and a second material member of the packaging device.
